(19) United States
(12) Patent Application Publication
(10) Pub. No.: US 2022/0248849 A1
(43) Pub. Date: Aug. 11, 2022

(54) Lally Column Shelf

(71) Applicants: Stephen Crecco, Carmel, NY (US); Vincent Crecco, Mahopen, NY (US)

(72) Inventors: Stephen Crecco, Carmel, NY (US); Vincent Crecco, Mahopen, NY (US)

(21) Appl. No.: 17/171,921

(22) Filed: Feb. 9, 2021

(51) Int. Cl. A47B 96/06; F16B 2/08

(52) U.S. Cl. CPC A47B 96/06; F16B 2/08

(57) ABSTRACT

An article of manufacture for providing a lally column self-supporting shelf is disclosed. The lally column shelf has a center lally column shelf oriented about a lally column and resting upon a plurality of support members positioned around the lally column, the plurality of support members retained against the lally column extending radially outward and each having an attachment hole through each support member about a top surface of the support members, and a retention strap around the lally column passing through each of the attachment holes in the support members.

### TECHNICAL FIELD

This application relates in general to an article of manufacture for providing workshop storage, and more specifically, to an article of manufacture providing a lally column self-supporting shelf.

### BACKGROUND

In most houses and garage workshops, there are structural supports called lally columns that are usually 3-4″ wide. In many of these workshops, people keep many objects leaning against these lally columns as a location for storage. This arrangement presents a cluttered and potentially dangerous working environment. The creation of useful storage volume about these columns provides a means to organize these items and reduce the clutter while also making the items easily accessible. The lally columns themselves provide a mechanism to create storage items at varying heights to hold these items in the workshops.

Therefore, a need exists for an article of manufacture for providing a lally column self-supporting shelf. The present invention attempts to address the limitations and deficiencies in prior solutions according to the principles and example embodiments disclosed herein.

### SUMMARY

In accordance with the present invention, the above and other problems are solved by providing an article of manufacture for a lally column self-supporting shelf according to the principles and example embodiments disclosed herein.

In one embodiment, the present invention is an article of manufacture for providing a lally column self-supporting shelf. The lally column shelf has a center lally column shelf oriented about a lally column and resting upon a plurality of support members positioned around the lally column, the plurality of support members retained against the lally column extending radially outward and each having an attachment hole through each support member about a top surface of the support members, and a retention strap around the lally column passing through each of the attachment holes in the support members.

In another aspect of the present disclosure, each of the plurality of support members has the support member having the top surface and a column surface, the attachment hole about a junction of the top surface and the column surface, a top support member coupled to the top surface running from the column surface outward beyond an end of the top surface, and a column support member is oriented flush against the lally column and coupled to the inward side of the support member while running run parallel to the lally column from the top surface to beyond the bottom of each support member.

In another aspect of the present disclosure, the retention strap is a worm-hose screw type clamp, and the worm-hose screw type clamp being tightened to hold the plurality of support members against the lally column.

In another aspect of the present disclosure, the article of manufacture further comprises a second retention strap about the lally column and secured to the lally column having a bottom portion of each of the column support members extending angle of the support member where a second retention clamp may be used to secure the support to the lally column.

In another aspect of the present disclosure, the retention strap and the second retention strap are worm-hose screw type clamps, and each of the worm-hose screw type clamps being tightened to hold the plurality of support members against the lally column.

In another aspect of the present disclosure, the center lally column shelf, the plurality of support members, top support members, and the column support members are made of a material comprising one of the following: wood, aluminum, steel, PVC, and other some sort of other flexible plastic or synthetic materials.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of an article of manufacture providing a lally column self-supporting shelf according to the present invention.

FIG. 2 illustrates top perspective view of an article of manufacture for providing a lally column self-supporting shelf according to the present invention.

FIG. 3 illustrates a perspective view of support elements that are part of an article of manufacture for providing a lally column self-supporting shelf according to the present invention.

FIG. 4 illustrates single support members 301a-d used to attach a lally column shelf to the lally column according to the present invention.

FIG. 5 illustrates another view of an article of manufacture for providing a lally column self-supporting shelf and its components according to the present invention.

FIG. 6 illustrates an example embodiment of support members coupled to a lally column using two retention straps used to attach a lally column shelf to the lally column according to the present invention.

FIG. 7 illustrates an example embodiment of support members coupled to a lally column using one retention strap used to attach a lally column shelf to the lally column according to the present invention.

FIG. 8 illustrates another view of the example embodiment of support members coupled to a lally column using one retention strap used to attach a lally column shelf to the lally column according to the present invention.

FIGS. 9a-b illustrate a top and bottom view of the example embodiment of a lally column shelf according to the present invention.

FIG. 10 illustrates another view of an installed and in use article of manufacture for providing a lally column self-supporting shelf and its components according to the present invention.

### DETAILED DESCRIPTION

This application relates in general to an article of manufacture for providing workshop storage, and more specifically, to an article of manufacture for providing a lally column self-supporting shelf according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “handyman,” and “user” refer to an entity, e.g. a human, using a lally column self-supporting shelf associated with the invention. The term user herein refers to one or more users.

The term “invention” or “present invention” refers to the invention being applied for via the patent application with the title “Lally Column Shelf.” Invention may be used interchangeably with shelf.

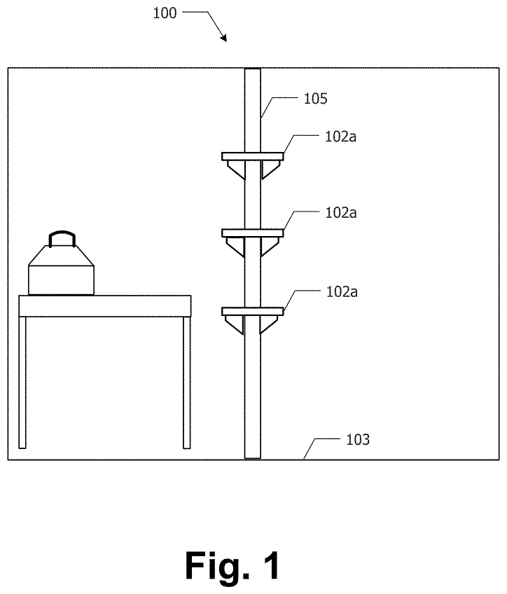

In general, the present disclosure relates to an article of manufacture for providing workshop storage. To better understand the present invention, FIG. 1 illustrates an example embodiment for an article of manufacture providing a lally column self-supporting shelf according to the present invention. A workshop 100 is shown having a lally column 105 located within the space. The lally column 105 is needed to provide structural support for the building having the workshop 100 in locations that are not always convenient for the workshop.

A set of lally column shelves 102a-c are shown attached to the lally column 105 at different heights above a floor 103. These lally column shelves 102a-c are wrapped around the column 105 providing a flat storage location about the typically less usable space about the lally column 105. The lally column shelves 102a-c may be made of differing widths out from the lally column 105 to provide space to hold objects of different sizes. The lally column shelves 102a-c are supported by a set of support members 301a-d (shown in FIG. 3) that are coupled to each of the lally column shelves 102a-c. Any number of lally column shelves 102a-c may be attached to the lally column 105 to provide a needed amount of storage.

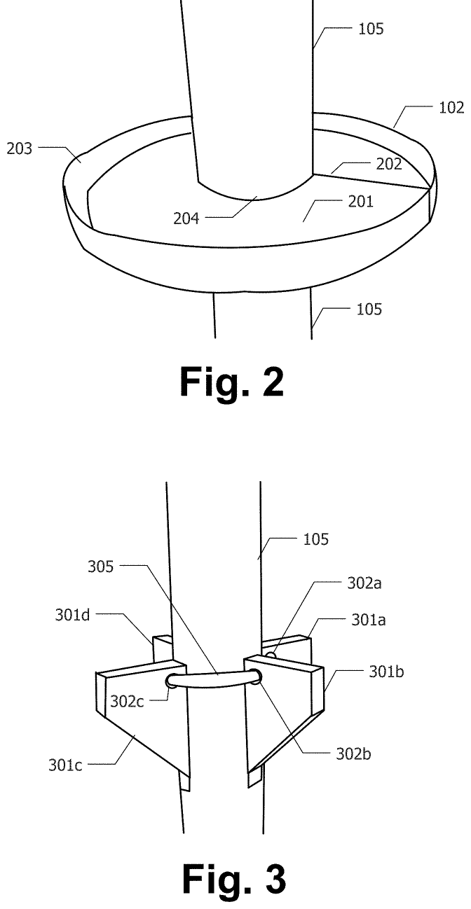

FIG. 2 illustrates a top perspective view of an article of manufacture for providing a lally column self-supporting shelf according to the present invention. A lally column shelf 102 is shown wrapped around a lally column 105. The lally column shelf 102 consists of a circular shelf surface 201 that encircles the lally column 105. The lally column shelf 102 includes a central opening 204 that matches the diameter of the lally column 105 to permit the lally column shelf 102 to be coupled flush against the lally column 105 to create a useable shelf.

The lally column shelf 102 also includes a diameter seam 202 between the central opening 204 and the outer edge 203 of the circular shelf surface 201. The diameter seam 202 permits the circular shelf surface 201 to open a sufficient distance to allow the circular shelf surface 201 to be placed about the lally column 105. Most lally columns are between 3-4″ in diameter and each side of the diameter seam 202 must separate from each other far enough to allow the 3-4″ column to pass in between.

FIG. 3 illustrates a perspective view of support elements that are part of an article of manufacture for providing a lally column self-supporting shelf according to the present invention. The set of support members 301a-d is shown about the lally column 105. Each of the support members 301a-d are positioned about the column 105 at approximately 90° of separation. The set of support members 301a-d is held against the lally column 105 using a retention strap 305 that wraps around the column 105 while passing through an attachment hole 302a-d within each of the support members 301a-d. By tightening the retention strap 305 about the lally column 105, the retention strap 305 presses the attachment hole 302a-d toward the column 105 to hold them in place. The set of support members 301a-d is positioned at a common height along the column to cause the top surfaces of the support members 301a-d providing a support surface for the circular shelf surface 201 to rest.

While a single retention strap 305 and corresponding attachment hole 302a-d are shown in each of the support members 301a-d, multiple retention straps (not shown) may be used to provide additional retention force to support large loads from items placed onto the shelves 102.

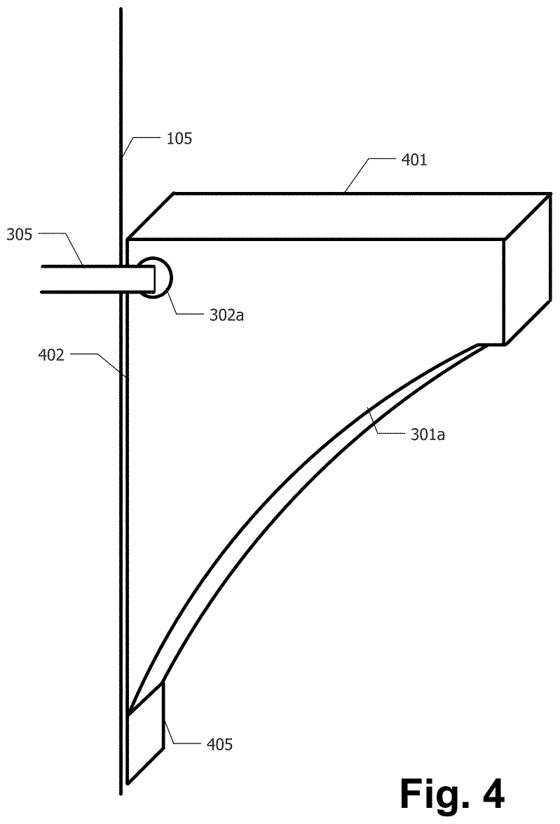

FIG. 4 illustrates single support members 301a-d used to attach a lally column shelf 102 to the lally column 105. Each support member 301a-d has a top support surface 401 and a column resting surface 402 perpendicularly arranged downward from the top support surface 401. The attachment holes 302a-d are positioned about the corner of the support members 301a-d where the top support surface 401 and the column resting surface 402 meet. The attachment hole 302a-d should be positioned close enough to the column resting surface 402 to allow the retention strap 305 to compress the material to hold the support members 301a-d against the lally column 105. Each of the support members 301a-d is thick enough to support the load imposed by the shelf 102 when it includes the items placed on top. A bottom attachment surface 405 may extend from the bottom of the support members 301a-d to provide an attachment surface to engage a second retention strap (not shown).

In a preferred embodiment, each of the support members are 6¼″ long by 6¼″ tall by 1″ deep. The bottom attachment surface 405 may be 1″ by 1″ to be large enough to engage the second retention strap. The attachment holes 302a-d, which are shown to be circular, may also be rectangular is shape. The attachment holes 302a-d are typically ⅝″ down and ⅝″ inward from the corner of the joining of the top support surface 401 and the column resting surface 402. A rectangular attachment slot (not shown) that replaces the attachment holes 302a-d is typically a 9/16″ by 3/32″ slot that is located ½″ down and ½″ inward from the above corner.

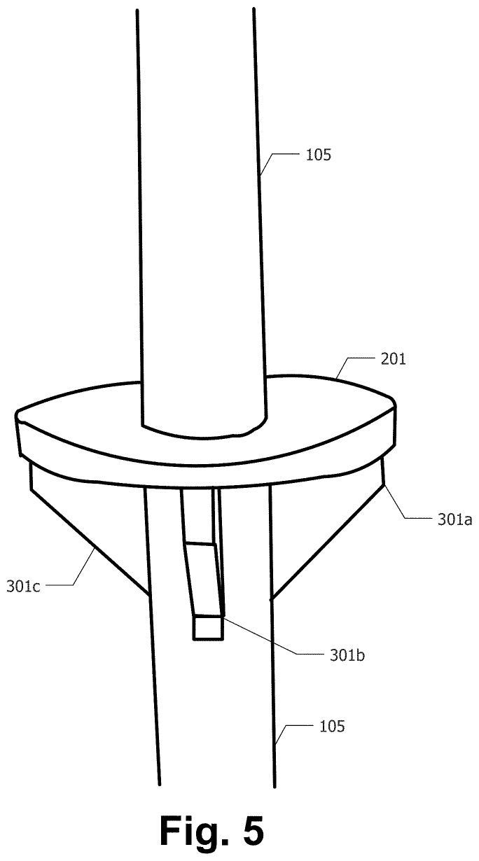

FIG. 5 illustrates another view of an article of manufacture for providing a lally column self-supporting shelf and its components according to the present invention. A complete lally column shelf 102 is shown having its circular shelf surface 201 about the lally column 105. The circular shelf surface 201 rests upon the set of support members 301a-d located about the lally column 105. Multiple lally column shelves 102 (not shown) may be attached to the lally column 105 in a manner shown in FIG. 1 disclosed above.

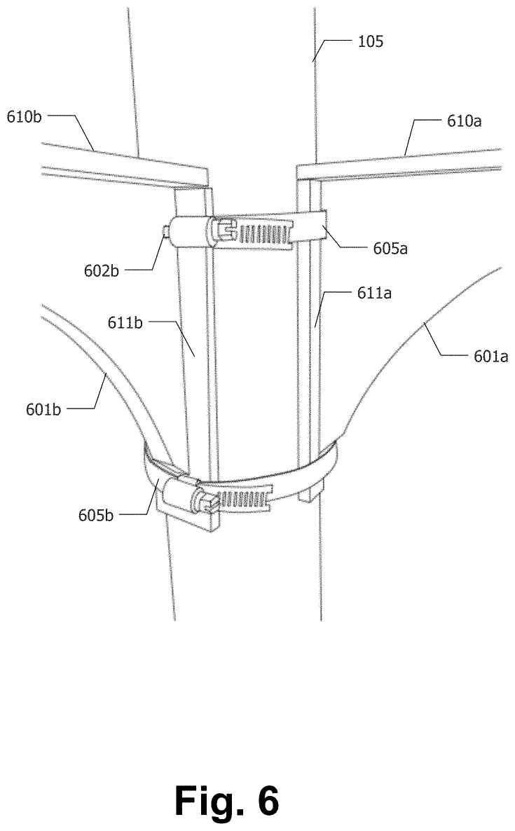

FIG. 6 illustrates an example embodiment of support members coupled to a lally column using two retention straps used to attach a lally column shelf to the lally column according to the present invention. FIG. 6 shows two adjacent support members 601a-b coupled to the lally column 105. A pair of retention straps 605a-b are used to hold the support members 601a-b to the lally column 105. The first of the two retention straps 705a wraps around the lally column 105 about the top edge of the support members 701a-b. The first of the two retention straps 705a passes through each of the attachment holes 602a-d through each of the support members 602a-d. The retention straps 705a-b may be worm/hose type clamps having a tightening screw that adjusts the length, and thus the retention force of the strap against the lally column 105. Other types of retention straps may be used. In the embodiment of FIG. 6, only two of the four support members 601a-d are visible with the remaining support members on the other side of the lally column 105 and out of view.

The support members 601a-b are shown with a top support member 610a-b and a column support member 611a-b that are coupled to the corresponding support member 601a-b. The top support member 610a-b is coupled to a top surface of the support member 601a-b and oriented radially outward from the lally column 105 to provide a support platform for a circular shelf surface (not shown) to rest. The column support member 611a-b is flush against the lally column 105 and coupled to the inward side of the support member 601a-b. The column support members 611a-b are oriented to run parallel to the lally column 105 from the top surface to beyond the bottom of each support member 601a-b. The first of the two retention straps 705a is placed about the lally column 105 and tightened with the second retention strap 705b placed upon the bottom portion of the column support members 611a-b that extend below the support members 601a-b. In this arrangement the support members 601a-b are held against the lally column 105 about both of their vertical ends to aid in securing the lally shelf 102 to the lally column 105.

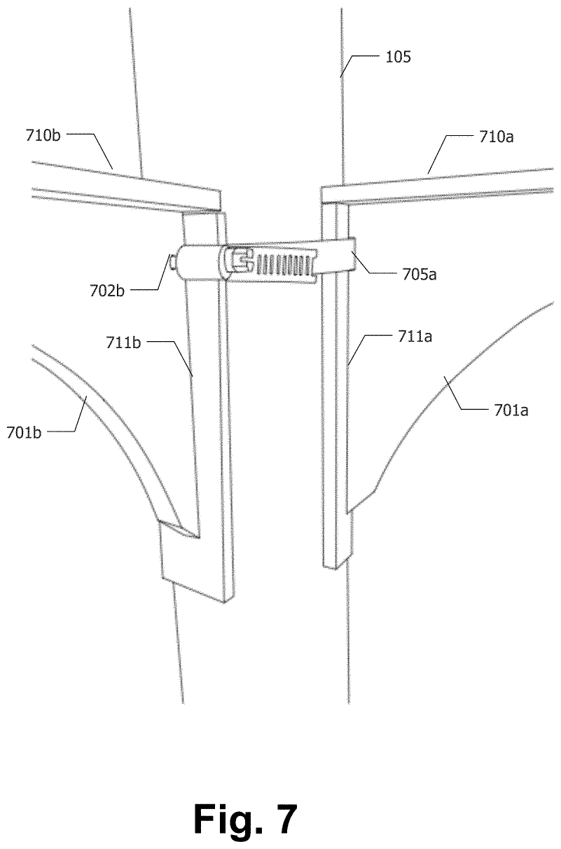

FIG. 7 illustrates an example embodiment of support members coupled to a lally column using one retention strap used to attach a lally column shelf to the lally column according to the present invention. FIG. 7 shows two adjacent support members 701a-b coupled to the lally column 105. A single retention straps 705a are used to hold the support members 701a-b to the lally column 105. The retention strap 705a wraps around the lally column 105 about the top edge of the support members 701a-b. The retention strap 705a passes through each of the attachment holes 702a-d through each of the support members 602a-d. The retention strap 705a may be worm/hose type clamps having a tightening screw that adjusts the length, and thus the retention force of the strap against the lally column 105. Other types of retention straps may be used. Similar to the embodiment that was disclosed above in reference to FIG. 6, only two of the four support members 701a-d are visible with the remaining support members on the otherwise of the lally column 105 and out of view.

The support members 701a-b are shown with a top support member 710a-b and a column support member 711a-b that are coupled to the corresponding support member 601a-b. The top support member 710a-b is coupled to a top surface of the support member 701a-b and oriented radially outward from the lally column 105 to provide a support platform for a circular shelf surface (not shown) to rest. The column support member 711a-b is flush against the lally column 105 and coupled to the inward side of the support member 701a-b. The column support members 711a-b are oriented to run parallel to the lally column 105 from the top to beyond the bottom of each support member 701a-b.

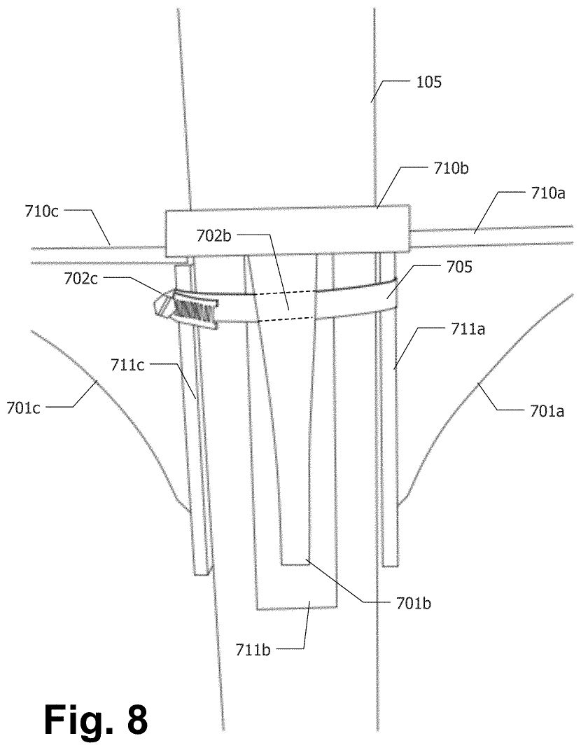

FIG. 8 another view of the example embodiment of support members coupled to a lally column using one retention strap used to attach a lally column shelf to the lally column according to the present invention. FIG. 8 shows a single retention strap embodiment of the lally shelf 100 in which three of the four support members 701a-c are visible. As above, the final support member 701d is not visible as it is directly behind the ally column 105 and oriented outward. The support members 701a-c all possess top support members 710a-c and column support members 711a-c as disclosed above. The single retention strap 705 passes through the attachment holes 702a-c on each of the support members 701a-c to secure the lally shelf 100 to the ally column 105.

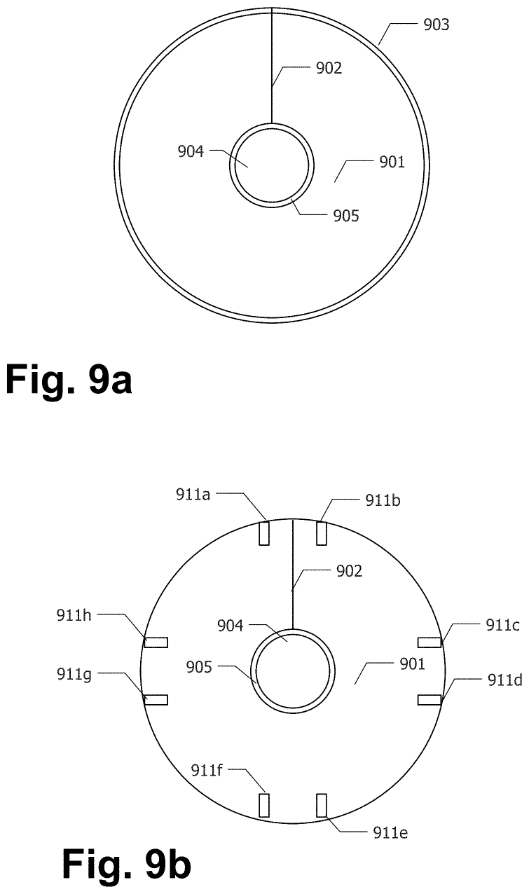

FIGS. 9a-b illustrate a top and bottom view of the example embodiment of a lally column shelf according to the present invention. FIG. 9a shows a top view of a lally shelf 901 having a raised lip 903. The lally shelf 901 is between 16″ and 17″ across having a thickness of at least ⅛″. The lally shelf 901 and all of the support members 701a-d shown above may be made of many materials including wood, aluminum, steel, PVC, and other some sort of other flexible plastic or synthetic materials. In a preferred embodiment, the lally shelf 901 and the support members 701a-d may be molded into a single piece of high-density polyethylene (HDPE). The lally shelf 901 has 1 1″ lip about its circumference to retain items placed upon the lally shelf 901. A center seam 902 extends from an outer edge about the lip to a center hole 904 provided to enclose around the lally column 105. The center hole 904 is 3½″ hole through the lally shelf 902 that includes a ½″ removable pull tab 905 that enlarges the center hole 904 to 4″. With the removable pull table 905, the lally shelf 901 may be used with both a 3½″ and a 4″ lally column. The shelf 901 is circular in shape with a cut seam 902 and hole 904 in the middle, when flexed, the shelf 901 will fit around the lally column 105 and sit on the shelf support members.

FIG. 9b shows an underside of the lally shelf 901 having the seam 902, the center hole 904, and pull tab 905 as described above. A set of stabilization tabs 911a-h are positions about the outer circumference of the lally shelf 901. A pair of stabilization tabs 911a-b are located on either side of the seam 902 and are 1″ long, ⅛″ wide. And ⅛″ high. These stabilization tabs 911a-b are separated a distance matching the width of top support member 710a-d of the support members 701a-d. When the lally shelf 901 is placed on top of a set of support members 701a-d after it has been coupled to the lally column 105, placement of the first top support member 710a between these stabilization tabs 911a-b prevents the lally shelf 901 from rotating about the lally column 105. The remaining three pairs of stabilization tabs 911c-d, 911e-f, and 911g-h are located about the outer circumference of the lally shelf 901 at 90°, 180°, and 270° from the first pair of stabilization tabs 911a-b. Each of these pairs of stabilization tabs 911c-d, 911e-f, and 911g-h engage the remaining top support members 710b-d.

Of course, other sized center holes 904 may be made to match a diameter of other lally columns. Additionally, other dimensions of the lally shelf 901 may be used to make larger and smaller sized shelves. Corresponding changes may be needed to the support members 701a-d to match any changes made to the lally shelf 901 itself.

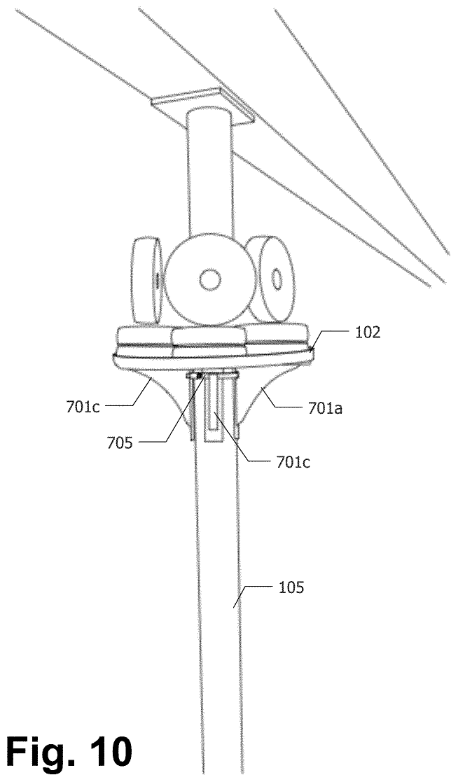

FIG. 10 illustrates a view of an installed and in use article of manufacture for providing a lally column self-supporting shelf and its components according to the present invention. A lally shelf 102 is shown coupled to a lally column 105. A lally column shelf 102 is placed upon the set of support members 701a-c and secured by a single retention strap 705. Items to be stored may be placed upon the lally column shelf 102 for safe keeping. Although not shown, additional lally column shelves 102 may be coupled to the same lally column 105 at different heights from the floor to provide multiple selves to hold objects out of the way within the same vertical space. These separate lally shelves 102 may be spaced apart along the lally column 105 at any desired distance as needed to hold the desired items depending upon the size of these items.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing a lally column self-supporting shelf, the article comprises:
a center lally column shelf oriented about a lally column and resting upon a plurality of support members positioned around the lally column;
the plurality of support members retained against the lally column extending radially outward and each having an attachment hole through each support member about a top surface of the support members; and
a retention strap around the lally column passing through each of the attachment holes in the support members.

2. The article of manufacture according to claim 1, wherein each of the plurality of support members comprises:
the support member having the top surface and a column surface;
the attachment hole about a junction of the top surface and the column surface;
a top support member coupled to the top surface running from the column surface outward beyond an end of the top surface; and
a column support member is oriented flush against the lally column and coupled to the inward side of the support member while running run parallel to the lally column from the top surface to beyond the bottom of each support member.

3. The article of manufacture according to claim 1, wherein the retention strap is a worm-hose screw type clamp; and
the worm-hose screw type clamp being tightened to hold the plurality of support members against the lally column.

4. The article of manufacture according to claim 1, wherein the article of manufacture further comprises a second retention strap about the lally column and secured to the lally column having a bottom portion of each of the column support members extending below the angle support to accept a second retention strap.

5. The article of manufacture according to claim 4, wherein the retention strap and the second retention strap are worm-hose screw type clamps; and
each of the worm-hose screw type clamps being tightened to hold the plurality of support members against the lally column.

6. The article of manufacture according to claim 4, wherein the center lally column shelf, the plurality of support members, top support members, and the column support members are made of a material comprising one of the following: wood, stainless steel, fiberglass, and other metals.
